(19) United States
(12) Patent Application Publication
(10) Pub. No.: US 2026/0251892 A1
(43) Pub. Date: Aug. 27, 2026

(54) System and Method of Epi-Illuminaton for a Microscope Array

(71) Applicant: Ramona Optics, Inc., Durham, NC (US)

(72) Inventors: Mark Harfouche, Durham, NC (US); Gregor John Horstmeyer, Durham, NC (US); Robert Horstmeyer, Palo Alto, CA (US); Aurélien Gauthier Florent Bègue, Durham, NC (US); Veton Saliu, Hillsborough, NC (US)

(21) Appl. No.: 19/054,785

(22) Filed: Feb. 15, 2025

(51) Int. Cl. G02B 21/06; G02B 21/36

(52) U.S. Cl. CPC G02B 21/06; G02B 21/361

(57) ABSTRACT

A system for imaging multi-well plates comprises a micro-camera array, an illumination array, a scanning mechanism, a controller, and a processor. The scanning mechanism moves the micro-camera and illumination arrays in three dimensions relative to the multi-well plate. The controller positions the arrays, activates illumination, and captures image data. The processor generates 3D measurements of specimens within wells. The system provides even illumination across wells using optimized optical elements and a polymer-dispersed liquid crystal sheet. It enables rapid 3D imaging and analysis of specimens across high-density well plates. The processor maps image data to per-specimen 3D measurements, generates statistics, and tracks specimens longitudinally. This novel, efficient system allows high-throughput 3D imaging and analysis of multicellular specimens.

### FIELD OF THE INVENTION

The present invention relates generally to microscopy and imaging technology, and more particularly to an epi-illumination system for high-throughput fluorescence and bright-field imaging using a densely packed microscope array.

### BACKGROUND OF THE INVENTION

Epi-illumination is a widely used technique in optical microscopy for imaging biological and industrial samples. It enables fluorescence and bright-field imaging by directing illumination light through the same optical path used for image acquisition. Epi-illumination systems are essential for applications such as high-throughput screening, cellular analysis, and fluorescence-based detection in research and diagnostic environments. However, traditional epi-illumination systems face several limitations related to uniformity, scalability, and structured light delivery, particularly when integrated into densely packed microscope arrays.

Many conventional fluorescence imaging systems employ discrete illumination sources placed outside the optical axis, resulting in uneven illumination across the sample. These systems often use external light guides or fiber optic bundles to direct excitation light toward the sample. However, such configurations lead to spatially varying excitation intensities, reducing fluorescence signal consistency and overall image quality. Additionally, existing epi-illumination techniques struggle with optical losses due to the use of complex beam-splitting elements and inefficient coupling between the illumination source and the imaging system.

Several attempts have been made to improve epi-illumination efficiency in high-content imaging applications. United States patent US8174761B2 describes a fluorescence microscope with an integrated light source, where illumination is introduced at an oblique angle relative to the optical axis. This design reduces background fluorescence but does not ensure uniform illumination across a densely packed microscope array. Furthermore, the system relies on external adjustment mechanisms, which limit its scalability for high-throughput imaging.

Another approach, detailed in United States patent US7551351B2, involves the use of an optical system with multiple light paths for selective illumination of a sample. This system includes a beam-splitting mechanism that directs excitation light toward different regions of the sample, improving illumination flexibility. However, this method requires complex mechanical alignment of optical components, which poses challenges for dense microscope arrays where precise and compact light delivery is critical.

Further, Canadian patent application CA2703242A1 discloses a system for fluorescence imaging using a high-sensitivity camera and controlled illumination timing to improve signal-to-noise ratios. The disclosed system enhances fluorescence detection sensitivity. However, it does not address the challenges of integrating epi-illumination into a compact, parallelized microscope array. Additionally, it lacks an optimized light-guiding structure to ensure uniform excitation across multiple imaging systems.

Existing microscope array systems are further constrained by their reliance on external illumination sources that require precise alignment with each optical path. These systems do not scale efficiently for high-density configurations, as each imaging module requires independent illumination control. Moreover, prior art systems often suffer from significant stray light artifacts and optical losses, limiting their effectiveness for high-resolution fluorescence microscopy.

Accordingly, there is a need for an epi-illumination system that overcomes these limitations by providing structured, uniform, and scalable illumination within a densely packed microscope array.

### SUMMARY OF THE INVENTION

To address the foregoing problems, in whole or in part, and/or other problems that may have been observed by persons skilled in the art, the present disclosure provides compositions and methods as described by way of example as set forth below.

The present disclosure addresses a need for an epi-illumination system that overcomes various limitations of conventional system by providing structured, uniform, and scalable illumination within a densely packed microscope array through integration of a compact light-guiding structure that efficiently couples illumination light into each imaging system, ensuring consistent excitation intensity while minimizing stray light artifacts. This advancement enables high-throughput fluorescence and bright-field imaging with improved signal-to-noise ratios and reduced optical losses.

In one aspect, a microscope array system is provided. The system comprises a plurality of imaging systems arranged in a two-dimensional array, each imaging system including an objective lens, a tube lens, an image sensor, a beam splitter, and a structured illumination mechanism. The beam splitter is positioned between the objective lens and the tube lens and is configured to reflect illumination light from an illumination source toward the sample while allowing collected light from the sample to pass through to the tube lens. The system further includes a structured light delivery system that provides uniform epi-illumination across the microscope array, ensuring efficient excitation for fluorescence imaging and improving signal-to-noise ratios.

In an embodiment, the beam splitter is a dichroic beam splitter, selectively reflecting excitation wavelengths while transmitting emission wavelengths. This configuration enables high-efficiency fluorescence imaging while minimizing background light contamination.

In another embodiment, the imaging systems within the microscope array are arranged in a two-dimensional configuration. This layout allows for parallelized imaging of large sample areas, significantly increasing imaging throughput while maintaining high spatial resolution.

In yet another embodiment, each imaging system is configured to receive illumination light from a structured light delivery mechanism comprising a light pipe periscope. The light pipe periscope is designed to provide a compact and rigid illumination pathway, ensuring uniform light distribution across the entire field of view of each imaging system.

In still another embodiment, the light pipe periscope comprises a material with a single index of refraction that guides illumination light via total internal reflection. Alternatively, the light pipe periscope may include an array of optical fibers or a cylindrical tube with a reflective interior, optimizing light transmission efficiency.

In a further embodiment, the light pipe periscope is configured to deliver illumination light to the beam splitter in a structured manner, improving spatial coherence and illumination uniformity across the microscope array.

In another embodiment, the system includes a bush member positioned beneath the sample to prevent optical misalignment due to external vibrations or mechanical disturbances. The bush member ensures stability of the optical components, thereby maintaining image quality.

In yet another embodiment, the bush member is pivotally mounted within the system, allowing for adaptive positioning based on sample height variations. This configuration enables robust and flexible optical alignment.

In still another embodiment, the bush member includes a plurality of projections disposed on its surface, improving mechanical stability and preventing unwanted lateral shifts of the imaging system.

In a further embodiment, the system includes an LED extension board positioned near the beam splitter to provide direct illumination without requiring a bulky light-guiding structure. This configuration simplifies the optical assembly and improves illumination efficiency by enabling direct light coupling into the imaging system.

In another embodiment, the LED extension board is implemented as a printed circuit board (PCB) that supports electronic control and power delivery to the illumination source. This design allows for precise illumination modulation, enabling adaptive control of excitation wavelengths and intensity.

In yet another embodiment, the system includes a lifted LED board positioned near the beam splitter, further optimizing the optical pathway by reducing the distance between the illumination source and the imaging optics. This configuration improves the compactness of the imaging system while maintaining uniform epi-illumination.

In still another embodiment, the lifted LED board is implemented in an inverted orientation to allow more flexible placement of optical components while maintaining efficient structured illumination delivery. This arrangement enhances system scalability for high-throughput imaging applications.

In a further embodiment, the system incorporates an optimized arrangement of epi-illumination optics within a densely packed microscope array. The structured placement of beam splitters, mirrors, and light sources maximizes spatial efficiency while ensuring uniform illumination distribution across the array.

In another aspect, a method of structured epi-illumination in a microscope array system is provided. The method comprises generating illumination light from one or more light sources, directing the illumination light into a light-guiding structure, conditioning the illumination light using condensing optics and spatial filters, and redirecting the illumination light toward the sample using an angled reflective element. The method further includes reflecting the illumination light off a beam splitter toward the sample, allowing collected light to pass through the beam splitter to an image sensor, and acquiring image data for high-contrast fluorescence or bright-field imaging. The structured illumination pathway reduces stray light artifacts, enhances signal-to-noise ratios, and improves imaging efficiency across the densely packed microscope array.

In an embodiment, the method further comprises filtering the illumination light using an excitation filter and filtering the collected light using an emission filter. The use of an excitation filter ensures that only the desired wavelength of illumination light reaches the sample, reducing background noise and improving fluorescence signal specificity. The emission filter selectively transmits fluorescence emission wavelengths while blocking residual excitation light, thereby enhancing image contrast and signal-to-noise ratio for high-precision fluorescence imaging.

In another embodiment, the method further comprises generating illumination light from a second light source, guiding the illumination light from the second light source through a second light pipe periscope, and redirecting the illumination light from the second light source towards a second beam splitter. This configuration allows for multi-channel fluorescence imaging by enabling simultaneous or sequential excitation of multiple fluorophores, thereby increasing imaging versatility and improving spectral separation for applications requiring multi-wavelength detection.

In yet another aspect, a microscope array system for providing epi-illumination is provided. The microscope array system comprises a plurality of imaging systems arranged in an array, each imaging system comprising an objective lens, a tube lens, an image sensor, a beam splitter positioned between the objective lens and the tube lens, and an LED extension board configured to position one or more LEDs near the beam splitter for delivering illumination light. The LED extension board allows for compact and optomechanically stable placement of light sources, eliminating the need for bulky external light guides while improving illumination efficiency and spatial uniformity across the microscope array. This configuration enhances system scalability and simplifies integration into high-throughput imaging applications.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF DRAWINGS

Having thus described the subject matter of the present invention in general terms, reference will now be made to the accompanying drawings, which are not necessarily drawn to scale, and wherein:

FIG. 1 illustrates a prior art microscope system configured for imaging a sample using an array of imaging modules;

FIG. 2 illustrates a microscope array system configured for providing epi-illumination in accordance with an embodiment of the present disclosure;

FIG. 3 illustrates a schematic representation of an object scanning and array scanning configuration for a microscope array system, in accordance with an embodiment of the present disclosure;

FIG. 4 illustrates a schematic representation of an illumination light path configuration for a microscope array system, in accordance with an embodiment of the present disclosure;

FIG. 5 illustrates a schematic representation of a light pipe periscope for delivering structured epi-illumination within a microscope array system, in accordance with an embodiment of the present disclosure;

FIG. 6a illustrates a schematic representation of a microscope array system configured for single-channel fluorescence imaging using epi-illumination, in accordance with an embodiment of the present disclosure;

FIG. 6b illustrates a schematic representation of a microscope array system configured for single-channel fluorescence imaging using a dichroic beam splitter with optimized wavelength reflection and transmission properties, in accordance with an embodiment of the present disclosure;

FIG. 7 illustrates a schematic representation of a microscope array system configured for multi-channel fluorescence imaging using epi-illumination, in accordance with an embodiment of the present disclosure;

FIG. 8 illustrates a schematic representation of a microscope array system incorporating an LED extension board for epi-illumination, in accordance with an embodiment of the present disclosure;

FIG. 9 illustrates a schematic representation of a microscope array system configured for multi-channel fluorescence imaging using an LED extension board, in accordance with an embodiment of the present disclosure;

FIG. 10 illustrates a schematic representation of a microscope array system incorporating a lifted LED board for epi-illumination, in accordance with an embodiment of the present disclosure;

FIG. 11 illustrates a schematic representation of a microscope array system incorporating a lifted and inverted LED board for epi-illumination, in accordance with an embodiment of the present disclosure;

FIG. 12 illustrates a schematic representation of a microscope array system incorporating a densely packed arrangement of imaging systems configured for epi-illumination, in accordance with an embodiment of the present disclosure;

FIG. 13 illustrates a schematic representation of a microscope array system incorporating an optimized arrangement of epi-illumination components within a densely packed imaging array, in accordance with an embodiment of the present disclosure; and

FIG. 14 illustrates a flowchart of a method for providing epi-illumination in a microscope array system, in accordance with an embodiment of the present disclosure.

### DETAILED DESCRIPTION OF THE INVENTION

The example embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

As described more fully below, the present disclosure is directed to

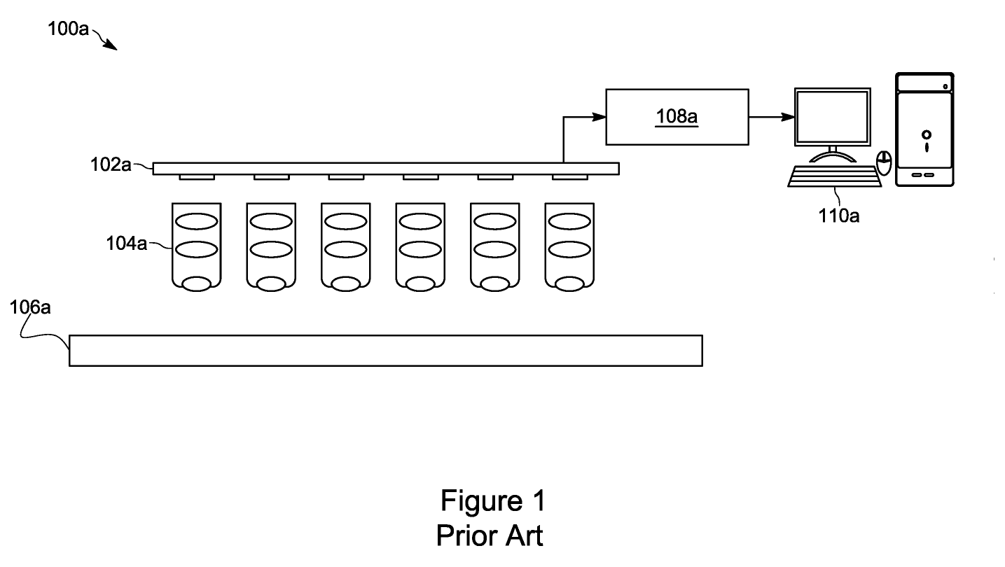

FIG. 1 illustrates a prior art microscope system 100a configured for imaging a sample using an array of imaging modules. The prior art microscope system 100a comprises a sensor array 102a, an objective lens 104a, an illumination source and a sample 106a positioned beneath the objective lens 104a. The system further includes a data pre-processing module 108a and a data processing module 110a, responsible for handling image data captured by the sensor array 102a.

In the prior art configuration, the illumination source is positioned externally relative to the objective lens 104a, leading to non-uniform illumination across the sample 108a. Additionally, due to such placement of the illumination source, significant stray illumination is introduced, resulting in unwanted reflections that reduce imaging contrast. The prior art microscope system 100a lacks an effective method to deliver compact, structured epi-illumination, limiting its use in fluorescence imaging and high-resolution applications. The prior art microscope system 100a is also not optimized for microscope arrays, making it challenging to scale for high-throughput imaging.

These drawbacks are addressed by the microscope array system of the present disclosure, which incorporates a light pipe periscope mechanism to enable structured, uniform, and scalable epi-illumination within a microscope array system.

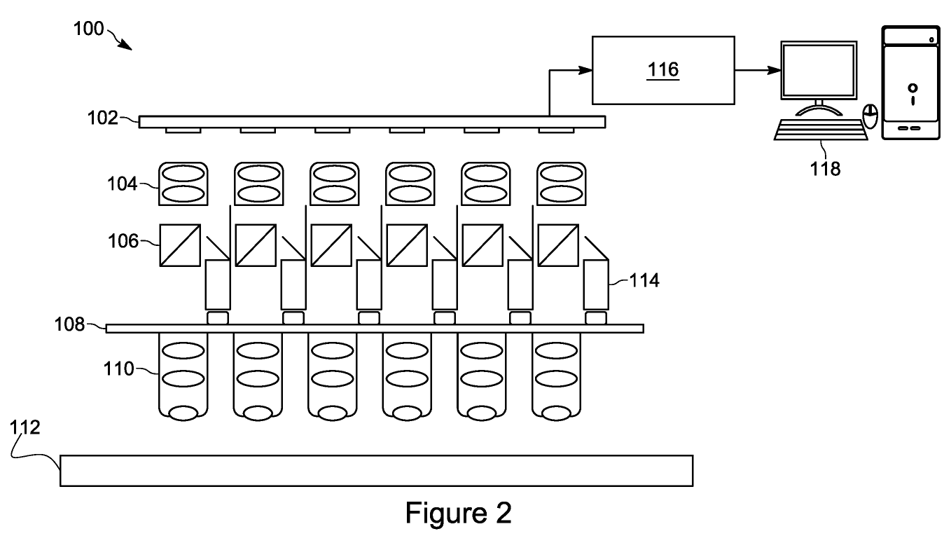

FIG. 2 illustrates a microscope array system 100 configured for providing epi-illumination, in accordance with an embodiment of the present disclosure. The microscope array system 100 comprises a sensor array 102, a tube lens 104, a beam splitter 106, an LED array 108, an objective lens 110, a sample 112, and a light pipe periscope 114. The microscope array system 100 further comprises a data pre-processing module 116 and a data processing, display and storage module 118.

The sensor array 102 is configured to capture image data of the sample 112. The tube lens 104 receives light from the sample 112 and directs it toward the sensor array 102. The beam splitter 106 is positioned between the objective lens 110 and the tube lens 104 and is configured to reflect illumination light from the light pipe periscope 114 toward the sample 112 while allowing collected light from the sample to pass through to the tube lens 104. In an embodiment, the beam splitter 106 is a dichroic beam splitter, selectively reflecting excitation wavelengths while transmitting emission wavelengths.

The LED array 108 generates illumination light for epi-illumination. The illumination light propagates through the light pipe periscope 114, which is configured to deliver the light to the beam splitter 106 in a structured manner. The light pipe periscope 114 provides a structurally rigid means to deliver light from the LED array 108 to the beam splitter 106. In an embodiment, the light pipe periscope 114 comprises a material with a single index of refraction that guides light via total internal reflection. In another embodiment, the light pipe periscope 114 comprises an array of fibers. In yet another embodiment, the light pipe periscope 114 comprises a cylindrical tube with a reflective interior.

The objective lens 110 is positioned to collect the illumination-reflected or fluorescence-emitted light from the sample 112 and direct it toward the tube lens 104. The microscope array system 100 is arranged in a two-dimensional configuration, allowing for efficient parallel imaging across a large sample area while ensuring uniform illumination across all imaging systems.

The microscope array system 100 provides a technical advantage over prior art systems by achieving a compact and scalable design for structured epi-illumination within a microscope array. The use of the light pipe periscope 114 improves spatial coherence and illumination uniformity, enhancing image quality in bright field and fluorescence imaging applications.

The microscope array system 100 further comprises a data pre-processing module 116 and a data processing, display, and storage module 118, which are configured to handle image acquisition, signal processing, and data management for high-throughput imaging applications. The data pre-processing module 116 is operatively connected to the image sensors within the microscope array and is responsible for aggregating raw image data, performing initial signal corrections, and applying noise reduction techniques before further processing. In an embodiment, the data pre-processing module 116 is implemented using a dedicated field-programmable gate array (FPGA) or an application-specific integrated circuit (ASIC) to enable real-time processing with minimal latency.

The data processing, display, and storage module 118 is configured to receive the pre-processed image data from the data pre-processing module 116 and further refine it using advanced computational techniques such as image stitching, feature extraction, and contrast enhancement. The processed data is then displayed in real-time for visualization and analysis, while simultaneously being stored in a high-capacity memory unit for later retrieval. In an embodiment, the data processing, display, and storage module 118 may include a graphical user interface (GUI) that allows users to manipulate and analyze the acquired image data efficiently. The integration of these modules within the microscope array system 100 enhances imaging throughput, reduces data processing overhead, and ensures seamless high-speed image acquisition, making the system well-suited for large-scale fluorescence and bright-field imaging applications.

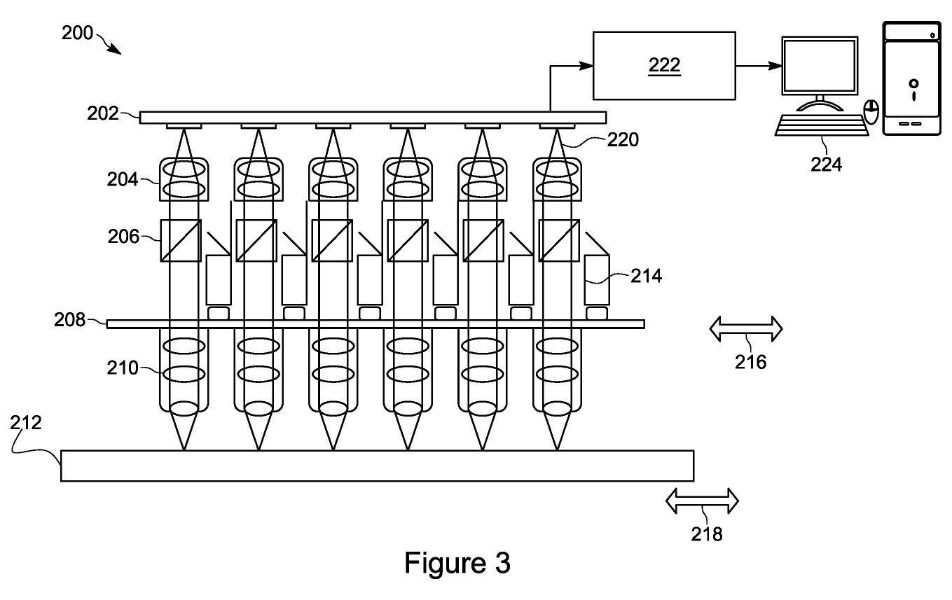

FIG. 3 illustrates a schematic representation of an object scanning and array scanning configuration for a microscope array system 200, in accordance with an embodiment of the present disclosure. The microscope array system 200 comprises a sensor array 202, a tube lens 204, a beam splitter 206, an LED array 208, an objective lens 210, a sample 212, a light pipe periscope 214, an array scanning mechanism 216, and an object scanning mechanism 218. As shown, the microscope array system 200 additionally comprises a data pre-processing module 222 and a data processing, display and storage module 224.

The sensor array 202 is configured to capture image data of the sample 212. The tube lens 204 receives light from the sample 212 and directs it toward the sensor array 202. The beam splitter 206 is positioned between the objective lens 210 and the tube lens 204 and is configured to reflect illumination light from the light pipe periscope 214 toward the sample 212 while allowing collected light from the sample to pass through to the tube lens 204. In an embodiment, the beam splitter 206 is a dichroic beam splitter, selectively reflecting excitation wavelengths while transmitting emission wavelengths.

The LED array 208 generates illumination light for epi-illumination along imaging light paths 220. Further, the illumination light is emitted for imaging along imaging light paths 220, ensuring efficient optical transmission from the sample to the imaging sensors. The illumination light propagates through the light pipe periscope 214, which is configured to deliver the light to the beam splitter 206 in a structured manner. The light pipe periscope 214 provides a structurally rigid means to deliver light from the LED array 208 to the beam splitter 206. In an embodiment, the light pipe periscope 214 comprises a material with a single index of refraction that guides light via total internal reflection. In another embodiment, the light pipe periscope 214 comprises an array of fibers. In yet another embodiment, the light pipe periscope 214 comprises a cylindrical tube with a reflective interior.

The object scanning mechanism 218 is configured to move the sample 212 relative to the microscope array system 200 to enable high-resolution imaging across a larger field of view. The array scanning mechanism 216 is configured to adjust the position of the sensor array 202 and associated optical components to facilitate scanning across the sample 212. The combination of object scanning and array scanning allows for extended imaging coverage while maintaining high spatial resolution.

The microscope array system 200 additionally comprises a data pre-processing module 222 and a data processing, display, and storage module 224. The data pre-processing module 222 is configured to aggregate raw image data from multiple imaging systems, apply initial corrections such as background subtraction and noise reduction, and prepare the data for further processing. The data processing, display, and storage module 224 receives the pre-processed image data and performs additional enhancements, including contrast adjustment and image stitching, before displaying the results in real-time. It also provides storage capabilities for later retrieval and analysis. The integration of these modules within the system 200 supports high-speed image acquisition and efficient data handling, making the system suitable for large-scale imaging applications requiring high-throughput analysis.

The microscope array system 200 provides a technical advantage over prior art systems by integrating structured epi-illumination with object and array scanning mechanisms, enabling large-area imaging with uniform illumination and high contrast. The structured illumination pathway ensures high signal-to-noise ratios, making the system well-suited for applications requiring large-scale fluorescence imaging, high-throughput microscopy, and real-time sample analysis.

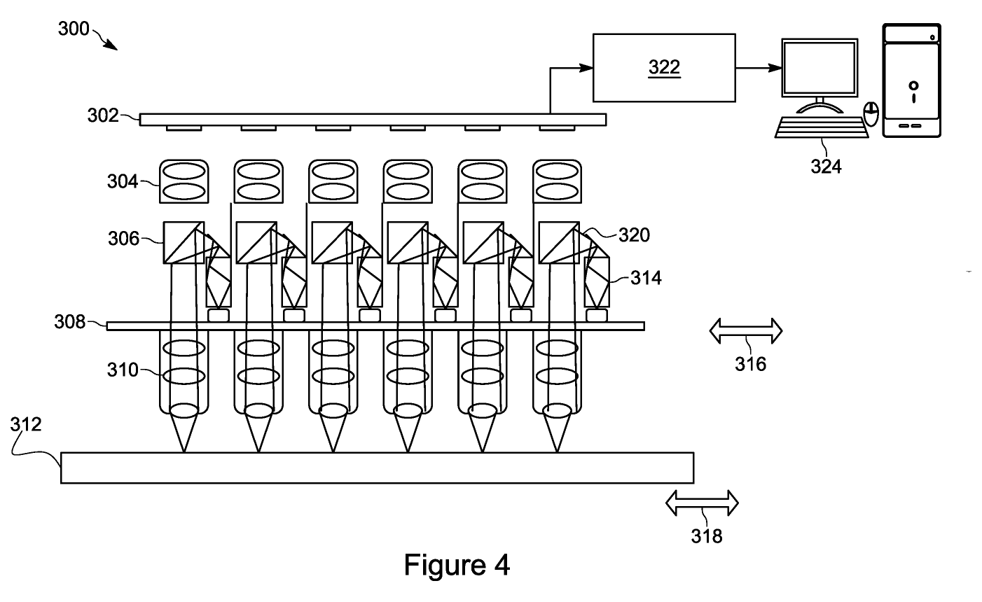

FIG. 4 illustrates a schematic representation of an illumination light path configuration for a microscope array system 300, in accordance with an embodiment of the present disclosure. The microscope array system 300 comprises a sensor array 302, a tube lens 304, a beam splitter 306, an LED array 308, an objective lens 310, a sample 312, a light pipe periscope 314, an object scanning mechanism 316 and an array scanning mechanism 318. The illumination light is emitted along an illumination light path 320. The microscope array system 300 further comprises a data pre-processing module 322 and a data processing, display and storage module 324.

The sensor array 302 is configured to capture image data of the sample 312. The tube lens 304 receives light from the sample 312 and directs it toward the sensor array 302. The beam splitter 306 is positioned between the objective lens 310 and the tube lens 304 and is configured to reflect illumination light from the light pipe periscope 314 toward the sample 312 while allowing collected light from the sample to pass through to the tube lens 304. In an embodiment, the beam splitter 306 is implemented as a dichroic beam splitter, selectively reflecting excitation wavelengths while transmitting emission wavelengths.

The LED array 308 generates illumination light for epi-illumination. The illumination light propagates through the light pipe periscope 314, which is configured to deliver the light to the beam splitter 306 in a structured manner. The light pipe periscope 314 provides a structurally rigid means to deliver light from the LED array 308 to the beam splitter 306. In an embodiment, the light pipe periscope 314 comprises a material with a single index of refraction that guides light via total internal reflection. In another embodiment, the light pipe periscope 314 comprises an array of fibers. In yet another embodiment, the light pipe periscope 314 comprises a cylindrical tube with a reflective interior.

The illumination light path 320 represents the structured delivery of excitation light from the LED array 308, through the light pipe periscope 314, and into the beam splitter 306, which redirects the light toward the sample 312. The structured illumination design ensures uniform and efficient epi-illumination across the sample, reducing stray light and improving image contrast.

The object scanning mechanism 316 is configured to move the sample 312 relative to the microscope array system 300, while the array scanning mechanism 318 is configured to adjust the position of the sensor array 302 and associated optical components. This combination allows for extended imaging coverage while maintaining high spatial resolution.

The microscope array system 300 provides a technical advantage over prior art systems by integrating structured epi-illumination with object and array scanning mechanisms. The structured illumination pathway enhances signal-to-noise ratios, reduces background noise, and ensures even fluorescence excitation across the sample. The system is well-suited for applications requiring large-scale fluorescence imaging, high-throughput microscopy, and real-time sample analysis.

The microscope array system 300 further comprises a data pre-processing module 322 and a data processing, display, and storage module 324. The data pre-processing module 322 is configured to receive raw image data from the imaging sensors and apply initial processing steps such as noise reduction, background correction, and normalization to enhance data quality before further analysis.

The data processing, display, and storage module 324 is responsible for refining the pre-processed image data, performing tasks such as image alignment, feature extraction, and multi-frame averaging for improved resolution and clarity. The processed data is then displayed in real-time for visualization and stored in a high-capacity memory system for later retrieval. The integration of these modules within the system 300 ensures seamless data acquisition, optimized processing efficiency, and scalable storage capabilities, making it suitable for high-throughput imaging applications.

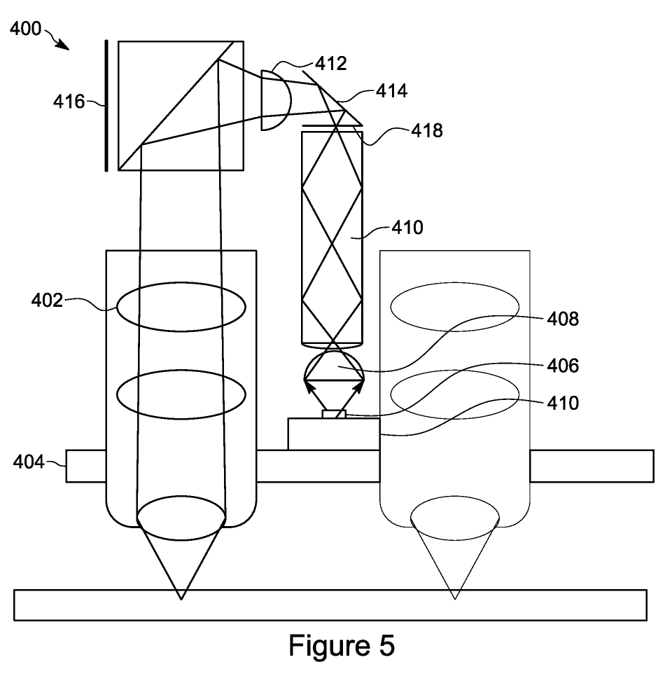

FIG. 5 illustrates a schematic representation of a light pipe periscope for delivering structured epi-illumination within a microscope array system 400, in accordance with an embodiment of the present disclosure. The microscope array system 400 comprises an objective lens 402, an optomechanical mount 404, one or more light sources 406, condensing optics 408, a hollow reflective light pipe 410, expanding optics 412, an angled mirror 414, a light baffle 416, and an aperture 418. The microscope array system 400 further comprises a PCB 420 for power delivery.

The objective lens 402 is configured to collect light from a sample and direct it toward a corresponding image sensor. The optomechanical mount 404 is configured to secure and align the light pipe periscope components in a stable and rigid configuration.

The one or more light sources 406 generate illumination light for epi-illumination. The light sources 406 may include LEDs, laser diodes, VCSELs, or a micro-LED array. In an embodiment, an external light-generating element may be configured to deliver light to the light source area via a fiber or fiber bundle.

The condensing optics 408 are positioned over the one or more light sources 406 and are configured to prevent excessive divergence of the emitted light before it enters the hollow reflective light pipe 410. The hollow reflective light pipe 410 is structured to guide illumination light in a controlled manner from the one or more light sources 406 toward the angled mirror 414. In an embodiment, the light pipe 410 comprises a material with a single index of refraction that guides light via total internal reflection. In another embodiment, the light pipe 410 comprises an array of fibers. In yet another embodiment, the light pipe 410 comprises a cylindrical tube with a reflective interior.

The expanding optics 412 are positioned along the illumination pathway and are configured to broaden the beam of light, ensuring uniform distribution across the back aperture of the objective lens 402. The angled mirror 414 is attached to the top end of the hollow reflective light pipe 410 and is configured to redirect the illumination light toward a beam splitter within the microscope array system.

The light baffle 416 is included to block stray light and prevent unwanted illumination artifacts that could interfere with image quality. The aperture 418 is positioned along the optical path and is configured to enhance the spatial coherence of the illumination light, ensuring that it forms a more uniform beam before it reaches the objective lens 402.

The light pipe periscope configuration of the microscope array system 400 provides a technical advantage over prior epi-illumination configurations by delivering structured and uniform illumination in a compact manner. The integration of condensing optics 408, expanding optics 412, and the light baffle 416 ensures high illumination uniformity while minimizing stray light artifacts. This structured light delivery system enhances imaging contrast and improves signal-to-noise ratios, making it particularly well-suited for high-resolution bright-field and fluorescence imaging applications.

The microscope array system 400 further comprises a PCB 420 for power delivery. The PCB 420 is configured to supply regulated electrical power to the illumination sources, image sensors, and processing modules, ensuring stable and efficient system operation. In an embodiment, the PCB 420 includes dedicated power distribution layers to minimize electrical noise and enhance signal integrity across the microscope array.

Additionally, the PCB 420 may integrate high-speed data connections, facilitating communication between imaging components and processing units while maintaining a compact and scalable design. The incorporation of the PCB 420 within the system 400 streamlines power management, reduces external wiring complexity, and improves overall reliability in high-throughput imaging applications.

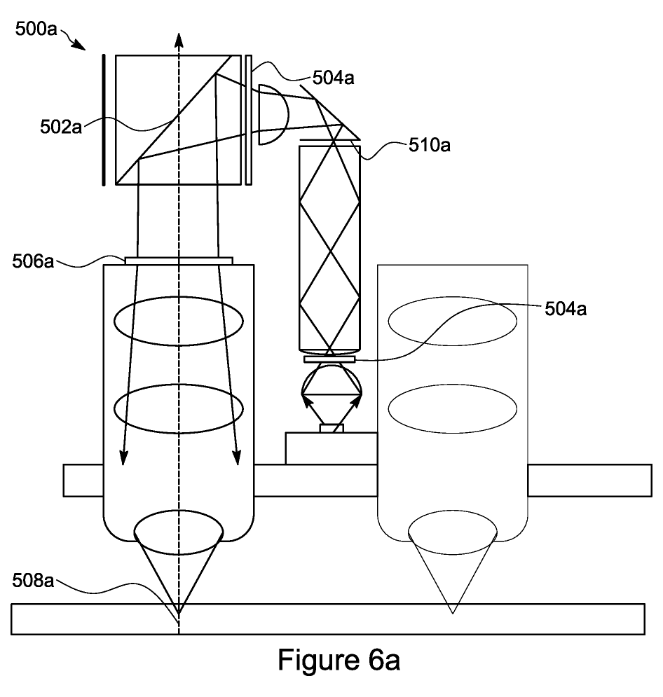

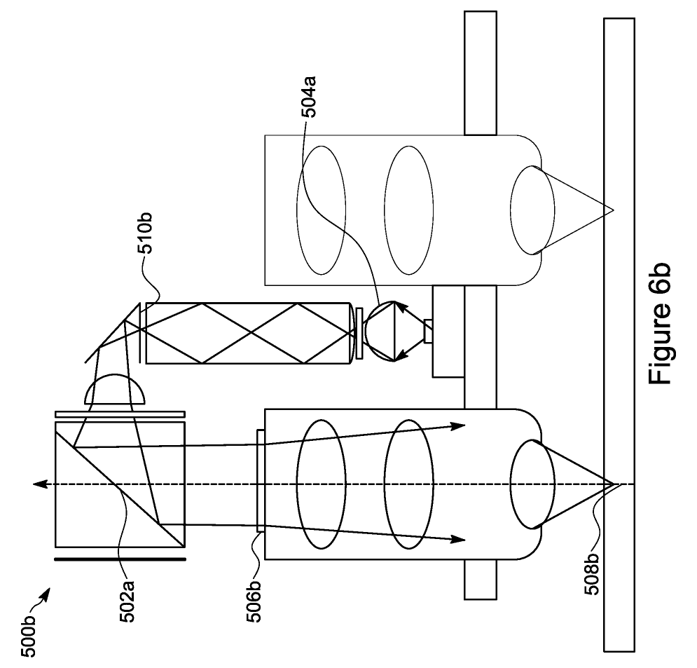

FIG. 6a illustrates a schematic representation of a microscope array system 500a configured for single-channel fluorescence imaging using epi-illumination, in accordance with an embodiment of the present disclosure. The microscope array system 500a comprises a dichroic beam splitter 502a, an excitation filters 504a, an emission filter 506a, a light source 508a configured for fluorescence emission, an aperture 510a, an objective lens, and an image sensor.

The dichroic beam splitter 502a is positioned between the objective lens and a tube lens and is configured to reflect excitation light from the light source 508a toward a sample while allowing fluorescence emission from the sample to pass through to the imaging system. In an embodiment, the dichroic beam splitter 502a is optimized to reflect a specific excitation wavelength range while transmitting the corresponding fluorescence emission wavelength range.

The excitation filters 504a are positioned within the illumination optical path and is configured to selectively transmit specific excitation wavelengths while blocking unwanted spectral components. The emission filter 506a is positioned within the detection optical path and is configured to selectively transmit fluorescence emission wavelengths while blocking residual excitation light. In an embodiment, the excitation filters 504a and emission filter 506a may be mounted on mechanical actuators to allow for selective movement in and out of the optical path, enabling dynamic control over fluorescence imaging.

The light source 508a generates illumination light for fluorescence excitation. The light source 508a may include one or more LEDs, lasers, laser diodes, VCSELs, or a micro-LED array. In an embodiment, the illumination light is guided to the dichroic beam splitter 502a through a structured light path, ensuring uniform delivery of excitation energy to the sample.

The aperture 510a is configured to improve the spatial coherence of the illumination light, ensuring that the excitation light forms a more uniform beam before reaching the sample. The objective lens collects fluorescence-emitted light from the sample and directs it toward the tube lens and image sensor. The image sensor is configured to capture fluorescence emission from the sample and may be implemented as a CMOS, sCMOS, SPAD array, CCD, or other high-sensitivity imaging technology.

The microscope array system 500a provides a technical advantage over prior fluorescence imaging configurations by incorporating a dichroic beam splitter 502a, an excitation filter 504a, and an emission filter 506a to ensure high selectivity for fluorescence excitation and emission. The structured optical arrangement improves imaging contrast while minimizing background noise, making the system well-suited for fluorescence-based microscopy applications.

FIG. 6b illustrates a schematic representation of a microscope array system 500b configured for single-channel fluorescence imaging using a dichroic beam splitter with optimized wavelength reflection and transmission properties, in accordance with an embodiment of the present disclosure. The microscope array system 500b comprises a dichroic beam splitter 502b, an excitation filter 504b, an emission filter 506b, a light source 508b configured to emit fluorescence emission, an aperture 510b, an objective lens, and an image sensor.

The dichroic beam splitter 502b is positioned within the optical path and is configured to reflect excitation light from the light source 508b toward the sample while allowing fluorescence emission to pass through to the imaging system. In an embodiment, the dichroic beam splitter 502b is designed to selectively reflect a first excitation wavelength while transmitting a fluorescence emission wavelength range. The optical properties of the dichroic beam splitter 502b enable efficient fluorescence excitation while ensuring minimal background noise in the detected emission signal.

The excitation filter 504b is positioned within the illumination optical path and is configured to selectively transmit the desired excitation wavelength while blocking unwanted spectral components. The emission filter 506b is positioned within the detection optical path and is configured to selectively transmit fluorescence emission wavelengths while blocking residual excitation light. In an embodiment, the excitation filter 504b and emission filter 506b may be mounted on mechanical actuators to allow for selective movement in and out of the optical path, providing dynamic fluorescence channel selection.

The light source 508b generates illumination light for fluorescence excitation. The light source 508b may include one or more LEDs, laser diodes, VCSELs, or a micro-LED array. In an embodiment, the light source 508b is structured to deliver excitation light in a controlled manner, ensuring uniform fluorescence excitation across the sample.

The aperture 510b is configured to improve the spatial coherence of the illumination light, ensuring that the excitation light forms a more uniform beam before reaching the sample. The objective lens collects fluorescence-emitted light from the sample and directs it toward the imaging sensor. The image sensor is configured to capture fluorescence emission from the sample and may be implemented as a CMOS, sCMOS, SPAD array, CCD, or other high-sensitivity imaging technology.

The microscope array system 500b provides a technical advantage over conventional single-channel fluorescence imaging systems by optimizing the dichroic beam splitter 502b for selective wavelength reflection and transmission, thereby improving fluorescence signal detection efficiency. The integration of the excitation filter 504b and emission filter 506b further enhances image contrast by ensuring precise fluorescence signal separation. This structured optical arrangement makes the system well-suited for applications requiring high-sensitivity fluorescence detection, including live-cell imaging, molecular diagnostics, and fluorescence-based industrial material inspection.

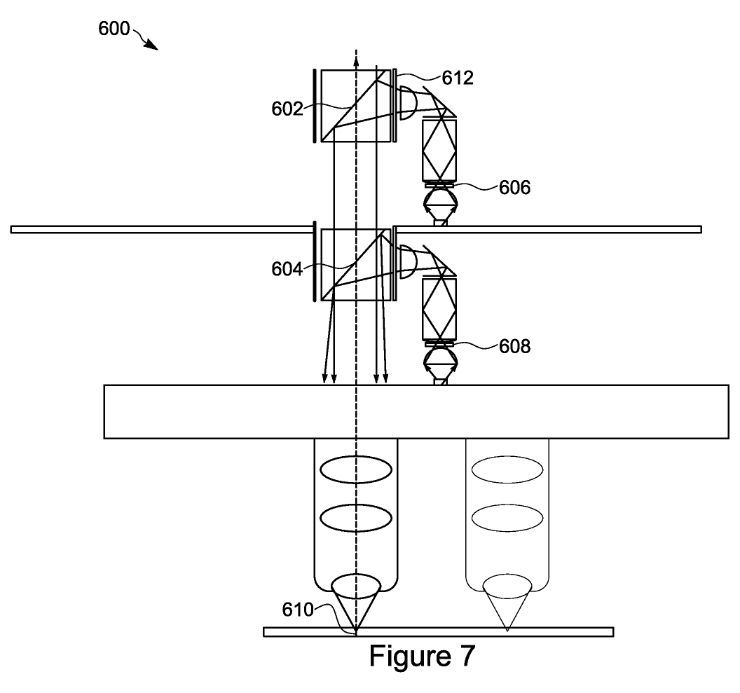

FIG. 7 illustrates a schematic representation of a microscope array system 600 configured for multi-channel fluorescence imaging using epi-illumination, in accordance with an embodiment of the present disclosure. The microscope array system 600 comprises a first dichroic beam splitter 602, a second dichroic beam splitter 604, a first excitation filter 606, a second excitation filter 608, a first emission filter, a second emission filter, a first excitation light source 610 configured for multi-channel fluorescence emision, and a second excitation light source. The microscope array system 600 further comprises a secondary excitation filter 612.

The first dichroic beam splitter 602 is positioned within the optical path and is configured to reflect excitation light from the first excitation light source 610 toward a sample while allowing fluorescence emission corresponding to a first fluorophore to pass through. The second dichroic beam splitter 604 is positioned within the optical path and is configured to reflect excitation light from the second excitation light source 616 while allowing fluorescence emission corresponding to a second fluorophore to pass through. In an embodiment, the first dichroic beam splitter 602 is optimized to reflect a first excitation wavelength range and transmit a first fluorescence emission wavelength range, while the second dichroic beam splitter 604 is optimized to reflect a second excitation wavelength range and transmit a second fluorescence emission wavelength range.

The first excitation filter 606 is positioned within the first illumination optical path and is configured to selectively transmit the first excitation wavelength range while blocking unwanted spectral components. The second excitation filter 608 is positioned within the second illumination optical path and is configured to selectively transmit the second excitation wavelength range. Similarly, the first emission filter 610 is positioned within the detection optical path and is configured to transmit fluorescence emission wavelengths corresponding to the first excitation wavelength while blocking residual excitation light. The second emission filter 612 is positioned within the second detection optical path and is configured to transmit fluorescence emission wavelengths corresponding to the second excitation wavelength. In an embodiment, the excitation filters 606 and 608, as well as the emission filters 610 and 612, may be mounted on mechanical actuators to allow selective movement in and out of the optical path, enabling dynamic selection of fluorescence imaging channels.

The first excitation light source 610 and second excitation light source 616 generate illumination light for fluorescence excitation and are configured to provide different excitation wavelengths. The excitation light sources 610 and 616 may include LEDs, laser diodes, VCSELs, or a micro-LED array. In an embodiment, each excitation light source 610 and 616 is positioned within a corresponding light pipe periscope, enabling efficient delivery of excitation light to the respective dichroic beam splitters 602 and 604.

The microscope array system 600 further comprises a secondary excitation filter 612. The secondary excitation filter 612 is configured to selectively transmit specific excitation wavelengths while blocking unwanted spectral components, thereby improving fluorescence signal specificity. In an embodiment, the secondary excitation filter 612 works in conjunction with a primary excitation filter to enable multi-wavelength excitation, allowing for the detection of multiple fluorophores within the same sample.

The integration of the secondary excitation filter 612 enhances imaging flexibility by enabling precise spectral separation and reducing crosstalk between fluorescence channels. This configuration improves signal-to-noise ratios and ensures high-contrast fluorescence imaging, making the system well-suited for applications requiring multi-channel detection and high-throughput screening.

The microscope array system 600 provides a technical advantage over single-channel fluorescence imaging systems by allowing for fluorescence detection at multiple excitation wavelengths using a combination of dichroic beam splitters, excitation filters, and emission filters. The ability to dynamically switch between fluorescence channels enhances imaging versatility by enabling the system to detect multiple fluorophores without requiring changes to the optical path. This structured optical arrangement makes the system well-suited for multi-wavelength fluorescence microscopy, high-throughput biomedical imaging, and fluorescence-based industrial applications.

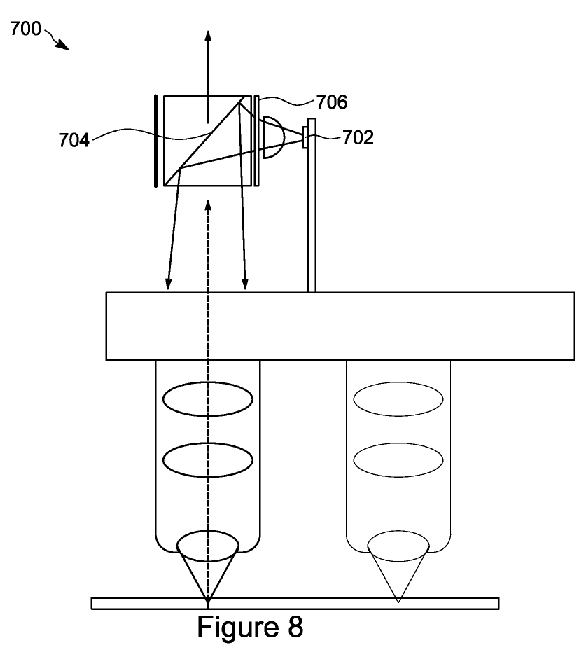

FIG. 8 illustrates a schematic representation of a microscope array system 700 incorporating an LED extension board for epi-illumination, in accordance with an embodiment of the present disclosure. The microscope array system 700 comprises an LED extension board 702, a dichroic beam splitter 704, an excitation filter 706, an emission filter, a light source 708, an objective lens, a tube lens, and an image sensor.

The LED extension board 702 is configured to position one or more LEDs near the dichroic beam splitter 704 for delivering illumination light to the microscope array system 700. The LED extension board 702 provides a compact and optomechanically stable means of positioning the light source 708 closer to the dichroic beam splitter 704, reducing the complexity associated with conventional light pipe periscopes while ensuring efficient delivery of excitation light for fluorescence imaging. In an embodiment, the LED extension board 702 is implemented as a printed circuit board (PCB) that supports power delivery and electronic control of the light source 708.

The dichroic beam splitter 704 is positioned within the optical path and is configured to reflect excitation light from the light source 708 toward the sample while allowing fluorescence emission to pass through to the image sensor. In an embodiment, the dichroic beam splitter 704 is optimized to reflect a specific excitation wavelength range while transmitting the corresponding fluorescence emission wavelengths.

The excitation filter 706 is positioned within the illumination optical path and is configured to selectively transmit excitation wavelengths while blocking unwanted spectral components. The emission filter 708 is positioned to filter emitted light from the sample and is configured to selectively transmit fluorescence emission wavelengths while blocking residual excitation light. In an embodiment, the excitation filter 706 and the emission filter 708 may be mounted on mechanical actuators to allow for selective movement in and out of the optical path, enabling dynamic selection of fluorescence imaging channels.

The light source 708 generates illumination light for fluorescence excitation and may include one or more LEDs, lasers, laser diodes, VCSELs, or a micro-LED array. In an embodiment, the microscope array system 700 may comprise multiple light sources, each configured to emit different wavelength ranges, allowing for multi-channel fluorescence imaging.

The objective lens is positioned to collect fluorescence-emitted light from the sample and direct it toward the tube lens. The tube lens receives the collected light and directs it toward the image sensor, where the light is converted into digital image data. The image sensor may be implemented as a CMOS, sCMOS, SPAD array, CCD, or other sensor technology capable of high-resolution image acquisition.

The LED extension board 702 provides a technical advantage over prior art illumination configurations by eliminating the need for bulky light pipe periscopes while ensuring precise positioning of the light source 708 relative to the dichroic beam splitter 704. The configuration enables a more compact and scalable microscope array system, improving the efficiency of structured epi-illumination in bright field and fluorescence imaging applications.

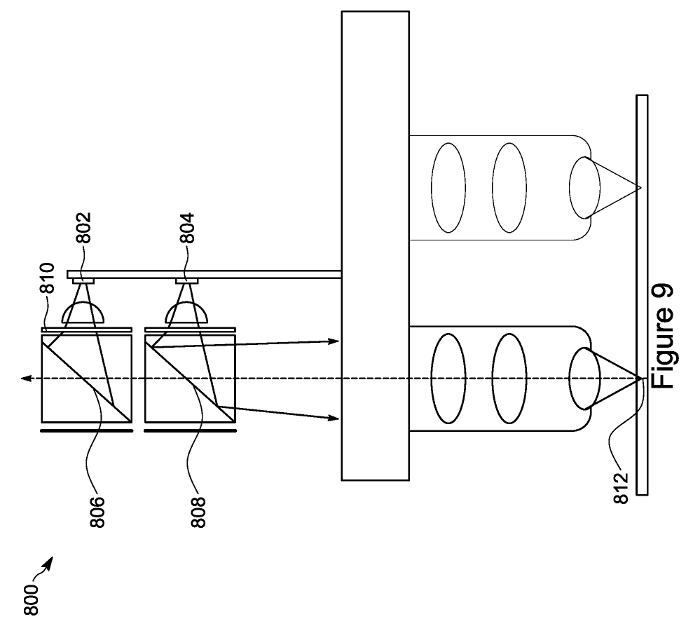

FIG. 9 illustrates a schematic representation of a microscope array system 800 configured for multi-channel fluorescence imaging using an LED extension board, in accordance with an embodiment of the present disclosure. The microscope array system 800 comprises a first LED extension board 802, a second LED extension board 804, a first dichroic beam splitter 806, a second dichroic beam splitter 808, a first excitation filter 810, a second excitation filter 810, a first emission filter, a second emission filter, a first LED light source 812, a second LED light source, an objective lens, a tube lens, and an image sensor.

The LED extension board 802 is configured to position multiple LED light sources near their respective dichroic beam splitters, ensuring efficient and compact illumination light delivery. The LED extension board 802 is implemented as a printed circuit board (PCB) that supports power delivery and electronic control of the first LED light source 812 and the second LED light source.

The first dichroic beam splitter 806 is positioned within the optical path and is configured to reflect excitation light from the first LED light source 812 toward the sample while allowing fluorescence emission corresponding to a first fluorophore to pass through. Similarly, the second dichroic beam splitter 808 is positioned within the optical path and is configured to reflect excitation light from the second LED light source while allowing fluorescence emission corresponding to a second fluorophore to pass through. In an embodiment, the first dichroic beam splitter 806 is optimized to reflect a first excitation wavelength range and transmit a first fluorescence emission wavelength range, while the second dichroic beam splitter 808 is optimized to reflect a second excitation wavelength range and transmit a second fluorescence emission wavelength range.

The first excitation filter 810 is positioned within the first illumination optical path and is configured to selectively transmit the first excitation wavelength range while blocking unwanted spectral components. The second excitation filter 810 is positioned within the second illumination optical path and is configured to selectively transmit the second excitation wavelength range. Similarly, the first emission filter is positioned within the detection optical path and is configured to transmit fluorescence emission wavelengths corresponding to the first excitation wavelength while blocking residual excitation light. The second emission filter is positioned within the second detection optical path and is configured to transmit fluorescence emission wavelengths corresponding to the second excitation wavelength. In an embodiment, the excitation filters 808 and 810, as well as the emission filters and, may be mounted on mechanical actuators to allow selective movement in and out of the optical path, enabling dynamic selection of fluorescence imaging channels.

The first LED light source 812 and the second LED light source generate illumination light for fluorescence excitation and are configured to provide different excitation wavelengths. The LED light sources 812 and may include LEDs, laser diodes, VCSELs, or a micro-LED array. The LED extension board 802 allows the first and second LED light sources to be positioned near their respective dichroic beam splitters, improving optical coupling efficiency and reducing the footprint of the epi-illumination system.

The objective lens is positioned to collect fluorescence-emitted light from the sample and direct it toward the tube lens. The tube lens receives the collected light and directs it toward the image sensor, where the light is converted into digital image data. The image sensor may be implemented as a CMOS, sCMOS, SPAD array, CCD, or other sensor technology capable of high-resolution image acquisition.

The microscope array system 800 provides a technical advantage over single-channel fluorescence systems by allowing for fluorescence detection at multiple excitation wavelengths using an LED extension board. The combination of dichroic beam splitters, excitation filters, and emission filters ensures high selectivity for fluorescence excitation and emission while minimizing spectral cross-talk. The integration of the LED extension board 802 allows for precise positioning of multiple excitation sources, reducing spatial constraints while maintaining high efficiency in epi-illumination. This configuration makes the system well-suited for high-throughput fluorescence imaging applications, including multi-wavelength biological imaging, fluorescence-based diagnostics, and industrial fluorescence inspection.

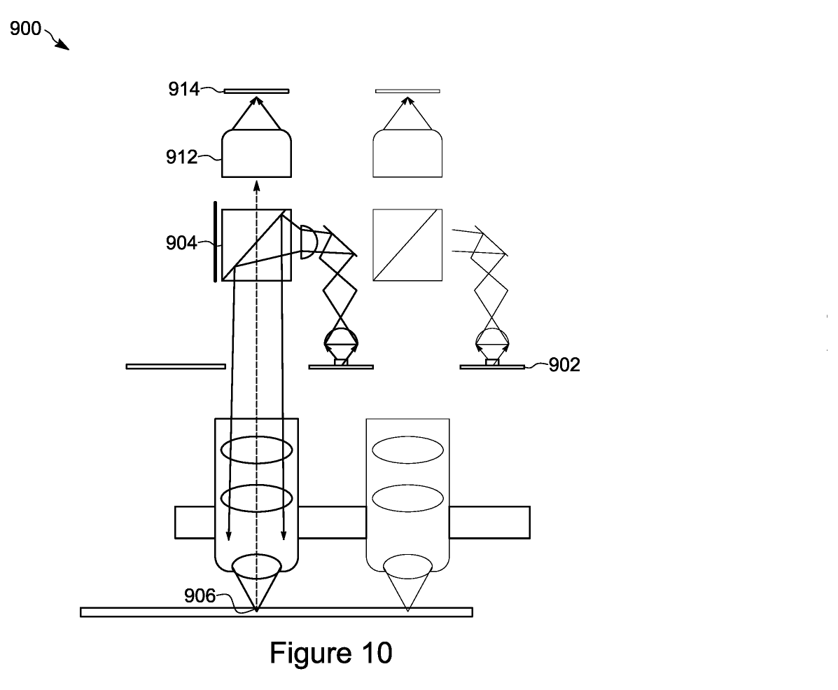

FIG. 10 illustrates a schematic representation of a microscope array system 900 incorporating a lifted LED board for epi-illumination, in accordance with an embodiment of the present disclosure. The microscope array system 900 comprises a lifted LED board 902, a dichroic beam splitter 904, an excitation filter, an emission filter, a light source 906 configured for multi-channel fluorescence emission, an objective lens, a tube lens 912, and an image sensor 914.

The lifted LED board 902 is configured to support and provide electronic control and power delivery to the light source 910 while positioning it near the dichroic beam splitter 904. Unlike light pipe periscope-based illumination systems, the lifted LED board 902 enables the placement of the light source 910 closer to the optical path, eliminating the need for complex light-guiding structures. In an embodiment, the lifted LED board 902 comprises a printed circuit board (PCB) with openings or windows cut into it to allow imaging light to pass through.

The dichroic beam splitter 904 is positioned within the optical path and is configured to reflect excitation light from the light source 910 toward the sample while allowing fluorescence emission to pass through to the image sensor 914. In an embodiment, the dichroic beam splitter 904 is optimized to reflect a specific excitation wavelength range while transmitting the corresponding fluorescence emission wavelengths.

The excitation filter is positioned within the illumination optical path and is configured to selectively transmit excitation wavelengths while blocking unwanted spectral components. The emission filter is positioned within the detection optical path and is configured to selectively transmit fluorescence emission wavelengths while blocking residual excitation light. In an embodiment, the excitation filter and the emission filter may be mounted on mechanical actuators to allow for selective movement in and out of the optical path, enabling dynamic selection of fluorescence imaging channels.

The light source 910 generates illumination light for fluorescence excitation and may include one or more LEDs, laser diodes, VCSELs, or a micro-LED array. The lifted LED board 902 positions the light source 910 in free-space proximity to the dichroic beam splitter 904, enabling direct optical coupling of excitation light into the system. In an embodiment, the lifted LED board 902 is configured to support multiple LED sources, each emitting different excitation wavelengths to enable multi-channel fluorescence imaging.

The objective lens is positioned to collect fluorescence-emitted light from the sample and direct it toward the tube lens 912. The tube lens 912 receives the collected light and directs it toward the image sensor 914, where the light is converted into digital image data. The image sensor 914 may be implemented as a CMOS, sCMOS, SPAD array, CCD, or other sensor technology capable of high-resolution image acquisition.

The lifted LED board 902 provides a technical advantage over prior epi-illumination configurations by eliminating the need for bulky light pipe periscopes while enabling a compact and scalable illumination architecture. The free-space optical propagation of excitation light toward the dichroic beam splitter 904 ensures efficient epi-illumination while reducing system complexity and spatial constraints. The system is well-suited for high-throughput fluorescence imaging, multi-wavelength excitation, and applications requiring precise and uniform illumination delivery.

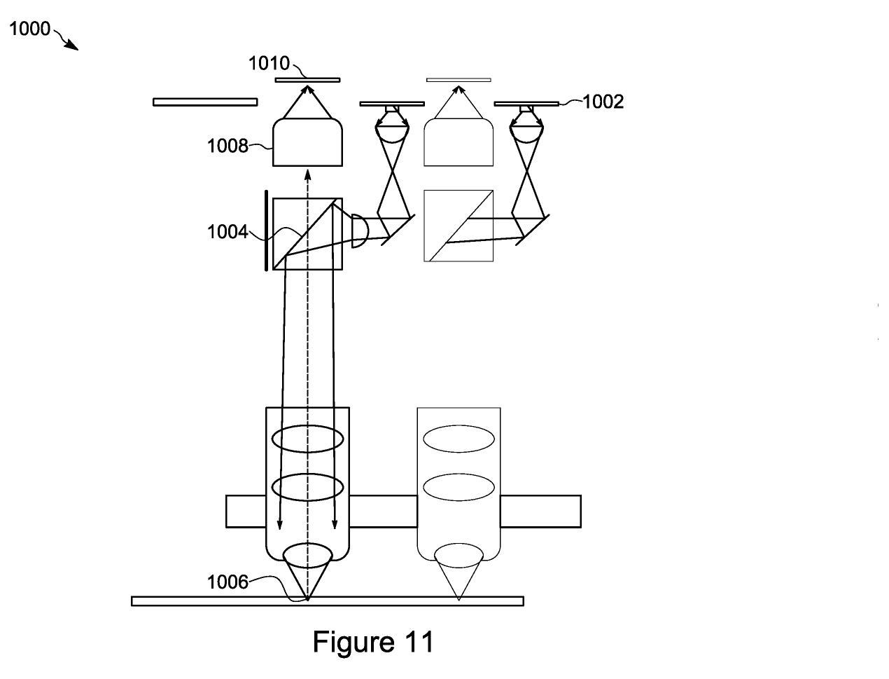

FIG. 11 illustrates a schematic representation of a microscope array system 1000 incorporating a lifted and inverted LED board for epi-illumination, in accordance with an embodiment of the present disclosure. The microscope array system 1000 comprises a lifted and inverted LED board 1002, a dichroic beam splitter 1004, an excitation filter, an emission filter, a light source 1006 configured for multi-channel fluorescence emission, an objective lens, a tube lens 1008, and an image sensor 1010.

The lifted and inverted LED board 1002 is configured to support and provide electronic control and power delivery to the light source 1010 while positioning it near the dichroic beam splitter 1004. Unlike conventional epi-illumination systems that rely on light pipe periscopes, the lifted and inverted LED board 1002 enables direct optical coupling of excitation light while maintaining a compact form factor. The inverted orientation of the LED board allows for more flexible placement of optical components. In an embodiment, the lifted and inverted LED board 1002 comprises a printed circuit board (PCB) with openings or windows cut into it to allow imaging light to pass through.

The dichroic beam splitter 1004 is positioned within the optical path and is configured to reflect excitation light from the light source 1010 toward the sample while allowing fluorescence emission to pass through to the image sensor 1010. In an embodiment, the dichroic beam splitter 1004 is optimized to reflect a specific excitation wavelength range while transmitting the corresponding fluorescence emission wavelengths.

The excitation filter is positioned within the illumination optical path and is configured to selectively transmit excitation wavelengths while blocking unwanted spectral components. The emission filter is positioned within the detection optical path and is configured to selectively transmit fluorescence emission wavelengths while blocking residual excitation light. In an embodiment, the excitation filter and the emission filter may be mounted on mechanical actuators to allow for selective movement in and out of the optical path, enabling dynamic selection of fluorescence imaging channels.

The light source 1010 generates illumination light for fluorescence excitation and may include one or more LEDs, laser diodes, VCSELs, or a micro-LED array. The lifted and inverted LED board 1002 positions the light source 1010 in free-space proximity to the dichroic beam splitter 1004, enabling efficient light delivery for epi-illumination. In an embodiment, the lifted and inverted LED board 1002 is configured to support multiple LED sources, each emitting different excitation wavelengths to enable multi-channel fluorescence imaging.

The objective lens is positioned to collect fluorescence-emitted light from the sample and direct it toward the tube lens 1008. The tube lens 1008 receives the collected light and directs it toward the image sensor 1010, where the light is converted into digital image data. The image sensor 1010 may be implemented as a CMOS, sCMOS, SPAD array, CCD, or other sensor technology capable of high-resolution image acquisition.

The lifted and inverted LED board 1002 provides a technical advantage over prior epi-illumination configurations by eliminating the need for bulky light pipe periscopes while enabling a compact and scalable illumination architecture. The inverted placement of the LED board allows for more flexible system integration while maintaining efficient epi-illumination. The system is well-suited for high-throughput fluorescence imaging, multi-wavelength excitation, and applications requiring precise and uniform illumination delivery.

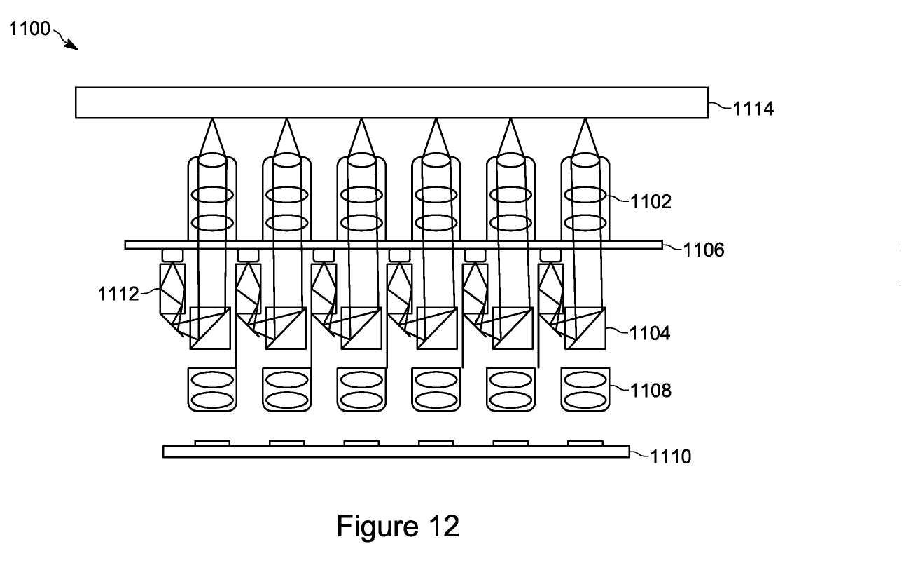

FIG. 12 illustrates a schematic representation of a microscope array system 1100 incorporating a densely packed arrangement of imaging systems configured for epi-illumination, in accordance with an embodiment of the present disclosure. The microscope array system 1100 comprises a plurality of objective lenses 1102, beam splitters 1104, light sources 1106, tube lenses 1108, image sensors 1110, and light pipe periscopes 1112.

The plurality of objective lenses 1102 are configured to collect light from a sample 1114 and direct it toward corresponding tube lenses 1108, which further focus the light onto image sensors 1110 for digital image capture. The beam splitters 1104 are positioned between the objective lenses 1102 and tube lenses 1108, reflecting illumination light from the light pipe periscopes 1112 toward the sample 1114 while allowing collected light from the sample 1114 to pass through to the tube lenses 1108. In an embodiment, the beam splitters 1104 are dichroic beam splitters optimized for selective reflection of excitation wavelengths and transmission of emission wavelengths.

The light sources 1106 are configured to generate illumination light for epi-illumination and may include LEDs, laser diodes, VCSELs, or micro-LED arrays. The light pipe periscopes 1112 are configured to deliver structured illumination from the light sources 1106 to the beam splitters 1104. The light pipe periscopes 1112 provide a structurally rigid means for guiding light while ensuring spatial coherence and minimizing stray light. In an embodiment, the light pipe periscopes 1112 comprise a material with a single index of refraction that guides light via total internal reflection. In another embodiment, the light pipe periscopes 1112 comprise an array of optical fibers. In yet another embodiment, the light pipe periscopes 1112 comprise cylindrical tubes with reflective interiors.

The microscope array system 1100 is arranged in a two-dimensional configuration, allowing for efficient parallel imaging across a large sample area while ensuring uniform illumination across all imaging systems. The dense packing of the imaging systems and epi-illumination components maximizes spatial efficiency while maintaining high image quality.

The microscope array system 1100 provides a technical advantage over prior art configurations by integrating densely packed epi-illumination optics within a scalable imaging system. The combination of beam splitters 1104, light sources 1106, and light pipe periscopes 1112 ensures structured light delivery with minimal stray light artifacts, enhancing image contrast and improving signal-to-noise ratios in bright field and fluorescence imaging applications.

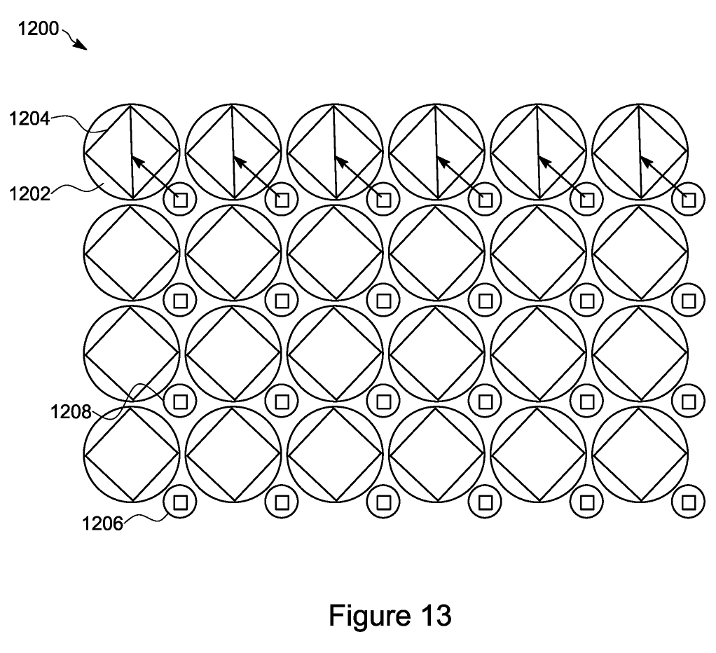

FIG. 13 illustrates a schematic representation of a microscope array system 1200 incorporating an optimized arrangement of epi-illumination components within a densely packed imaging array, in accordance with an embodiment of the present disclosure. The microscope array system 1200 comprises a plurality of objective lenses 1202, beam splitters and mirrors 1204 at 45-degree angle, light sources 1206, and light pipes 1208.

The plurality of objective lenses 1202 are configured to collect light from a sample and direct it toward corresponding imaging sensors. The beam splitters 1204 are positioned within the optical paths of the objective lenses 1202 and are configured to reflect illumination light from the light pipes 1208 toward the sample while allowing collected light from the sample to pass through to the imaging sensors. In an embodiment, the beam splitters 1204 are dichroic beam splitters optimized for selective reflection of excitation wavelengths and transmission of emission wavelengths.

The mirrors are positioned at a 45-degree angle relative to the optical axis and are configured to redirect illumination light from the light sources 1206 toward the beam splitters 1204. This angled positioning enables efficient light coupling while maintaining a compact arrangement of optical components.

The light sources 1206 serve as the illumination elements for epi-illumination and are positioned in open areas at diagonal intersections of the arrayed objective lenses 1202. In an embodiment, the light sources 1206 may include LEDs, laser diodes, VCSELs, or a micro-LED array, allowing for a variety of excitation wavelengths to be used for fluorescence imaging.

The light pipes 1208 are configured to guide illumination light from the light sources 1206 toward the beam splitters 1204. In an embodiment, the light pipes 1208 provide a structurally rigid means to deliver light from the light sources 1206 to the beam splitters 1204. The light pipes 1208 may comprise a material with a single index of refraction that guides light via total internal reflection. In another embodiment, the light pipes 1208 may comprise an array of fibers or a cylindrical tube with a reflective interior.

The microscope array system 1200 is arranged in a two-dimensional configuration, allowing for efficient parallel imaging across a large sample area while ensuring uniform illumination across all imaging systems. The structured placement of the epi-illumination components optimizes the available space within the densely packed imaging array, allowing for a compact and scalable system.

The microscope array system 1200 provides a technical advantage over prior art configurations by integrating epi-illumination optics in a manner that maximizes spatial efficiency while ensuring uniform illumination delivery. The combination of beam splitters 1204, mirrors, and light pipes 1208 enables structured light delivery with minimal stray light artifacts, improving overall imaging performance in bright field and fluorescence applications.

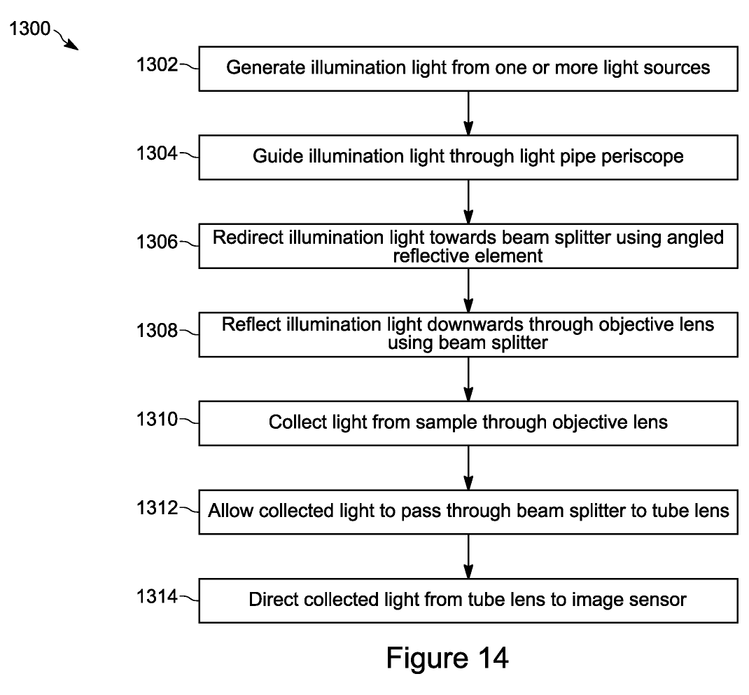

FIG. 14 illustrates a flowchart 1300 of a method for providing epi-illumination in a microscope array system, in accordance with an embodiment of the present disclosure. The method comprises seven steps, each contributing to structured illumination delivery and optimized image acquisition.

At step 1302, illumination light from one or more light sources is generated. The light sources may include LEDs, laser diodes, VCSELs, or a micro-LED array, ensuring high-efficiency light emission.

At step 1304, the generated illumination light is directed into a light-guiding structure. The light-guiding structure may include a light pipe periscope, an optical fiber array, or a reflective cylindrical tube, ensuring controlled and loss-minimized light transport.

At step 1306, the illumination light is conditioned by passing through condensing optics and spatial filters. This step improves beam uniformity and enhances spatial coherence, optimizing the quality of epi-illumination.

At step 1308, the conditioned illumination light is redirected using an angled reflective element. The angled reflective element, such as a mirror or beam splitter, precisely guides the light path toward the imaging system while maintaining system compactness.

At step 1310, the illumination light is reflected by a beam splitter toward a sample. The beam splitter is implemented as a dichroic element to selectively transmit emission light while reflecting excitation light, ensuring efficient fluorescence imaging.

At step 1312, light collected from the sample passes through the beam splitter and is directed toward an image sensor. This enables high-resolution imaging of fluorescence emission or reflected light from the sample.

At step 1314, image data is acquired and processed to generate high-contrast images. The structured illumination pathway reduces stray light artifacts and enhances signal-to-noise ratios, making the system well-suited for high-throughput fluorescence and bright-field imaging applications.

The method provides a technical advantage by ensuring structured, uniform, and loss-minimized epi-illumination within a densely packed microscope array, improving both image quality and system scalability.

In an embodiment, the one or more light sources are positioned on an LED extension board placed near the beam splitter, reducing the need for complex optical guiding elements. This configuration allows for direct coupling of excitation light into the optical path, improving illumination efficiency and system compactness.

In another embodiment, the one or more light sources are positioned externally and coupled to the microscope array system via a fiber optic bundle. This configuration enables the use of high-power external illumination sources while maintaining a compact imaging system, improving flexibility for high-intensity fluorescence applications.

### General Definitions

The term “microscope array system” as used herein relates to a system comprising multiple imaging systems arranged in an array, each imaging system including optical and electronic components for capturing image data from a sample.

The term “epi-illumination” as used herein relates to an illumination method in which light is directed toward a sample from the same side as the objective lens, allowing for reflection or fluorescence-based imaging.

The term “imaging system” as used herein relates to an individual optical unit within a microscope array, comprising an objective lens, a tube lens, an image sensor, a beam splitter, and associated illumination components.

The term “objective lens” as used herein relates to an optical element that collects light from a sample and directs it toward the imaging system, defining the system’s magnification and resolution characteristics.

The term “tube lens” as used herein relates to an optical element that receives light from the objective lens and directs it toward the image sensor, typically forming an image at the sensor plane.

The term “image sensor” as used herein relates to an electronic device that converts optical images into digital signals, typically implemented as a CMOS, sCMOS, SPAD array, CCD, or other sensor technology.

The term “beam splitter” as used herein relates to an optical element positioned between the objective lens and the tube lens, which reflects illumination light toward the sample while allowing imaging light to pass through to the tube lens.

The term “light pipe periscope” as used herein relates to a structured optical conduit that guides illumination light from a light source to a beam splitter, ensuring efficient delivery of light for epi-illumination.

The term “light source” as used herein relates to an illumination element that generates light for epi-illumination, including but not limited to LEDs, lasers, laser diodes, VCSELs, and micro-LED arrays.

The term “condensing optics” as used herein relates to optical elements positioned over the light source to control beam divergence and improve spatial coherence before the light enters the light pipe periscope.

The term “angled reflective element” as used herein relates to a component, such as a mirror or beam splitter, positioned at the end of a light pipe periscope to redirect light toward the beam splitter for sample illumination.

The term “aperture” as used herein relates to an optical element that increases spatial coherence by controlling the angular distribution of light passing through the illumination pathway.

The term “expanding optical element” as used herein relates to a lens or optical component that broadens the illumination beam to evenly illuminate the back aperture of the objective lens.

The term “light baffle element” as used herein relates to a structural component that prevents stray light from entering the beam splitter from unintended directions, improving illumination uniformity.

The term “dichroic beam splitter” as used herein relates to a beam splitter designed to selectively reflect or transmit specific wavelength ranges, allowing for controlled fluorescence excitation and emission.

The term “two-dimensional configuration” as used herein relates to an arrangement of imaging systems in a grid or planar format, enabling parallel imaging across a large sample area.

The term “total internal reflection” as used herein relates to the optical principle by which light is confined within a medium, such as a light pipe, due to the angle of incidence exceeding the critical angle at the material boundary.

The term “fiber array” as used herein relates to an optical bundle consisting of multiple fibers that guide light from the source to the beam splitter, enabling efficient light delivery.

The term “cylindrical tube with a reflective interior” as used herein relates to a hollow, tubular structure with an internal reflective coating, designed to guide light from the source to the beam splitter.

The term “optomechanical mount” as used herein relates to a structural component that holds and aligns multiple optical elements, including light pipes and beam splitters, to ensure precise illumination delivery.

The term “excitation filter” as used herein relates to an optical filter positioned within the illumination path to selectively transmit specific wavelengths used for fluorescence excitation.

The term “emission filter” as used herein relates to an optical filter positioned within the detection path to selectively transmit fluorescence emission wavelengths while blocking unwanted excitation light.

The term “LED extension board” as used herein relates to a printed circuit board or mechanical support that positions one or more LEDs near the beam splitter for direct light delivery.

The term “external light generating element” as used herein relates to a remote light source, such as a laser or LED array, that delivers illumination to the system via fiber optics or another optical conduit.

The term “illumination optical path” as used herein relates to the pathway through which illumination light travels from the source to the sample, including all optical elements involved in directing the light.

The term “collected light” as used herein relates to the light that is reflected or emitted from a sample and subsequently captured by the imaging system.

The term “fluorescence excitation” as used herein relates to the process of illuminating a sample with a specific wavelength of light to induce fluorescence emission from fluorophores within the sample.

The term “multi-channel fluorescence imaging” as used herein relates to a fluorescence imaging method that captures emissions from multiple fluorophores by using different excitation wavelengths and corresponding filters.

The term “switchable fluorescence channels” as used herein relates to the ability of the system to alternate between different fluorescence excitation and emission wavelength combinations, typically achieved through filter or light source switching.

The term “fluorescence emission” as used herein relates to the light emitted by a fluorophore after absorbing excitation light, typically shifted to a longer wavelength due to Stokes shift.

It will be appreciated that various aspects of the disclosure may be embodied as a method, system, computer readable medium, and/or computer program product. Aspects of the disclosure may take the form of hardware embodiments, software embodiments (including firmware, resident software, micro-code, etc.), or embodiments combining software and hardware aspects that may all generally be referred to herein as a “circuit,” “module,” or “system.” Furthermore, the methods of the disclosure may take the form of a computer program product on a computer-usable storage medium having computer-usable program code embodied in the medium.

Any suitable computer useable medium may be utilized for software aspects of the disclosure. The computer-usable or computer-readable medium may be, for example but not limited to, an electronic, magnetic, optical, electromagnetic, infrared, or semiconductor system, apparatus, device, or propagation medium. The computer readable medium may include transitory and/or non-transitory embodiments. More specific embodiments (a non-exhaustive list) of the computer-readable medium would include some or all of the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission medium such as those supporting the Internet or an intranet, or a magnetic storage device. Note that the computer-usable or computer-readable medium may even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Program code for carrying out operations of the disclosure may be written in an object-oriented programming language such as Java, Smalltalk, C++ or the like. However, the program code for carrying out operations of the disclosure may also be written in conventional procedural programming languages, such as the “C” programming language or similar programming languages. The program code may be executed by a processor, application specific integrated circuit (ASIC), or other component that executes the program code. The program code may be simply referred to as a software application that is stored in memory (such as the computer readable medium discussed above). The program code may cause the processor (or any processor-controlled device) to produce a graphical user interface (“GUI”). The graphical user interface may be visually produced on a display device, yet the graphical user interface may also have audible features. The program code, however, may operate in any processor-controlled device, such as a computer, server, personal digital assistant, phone, television, or any processor-controlled device utilizing the processor and/or a digital signal processor.

The program code may locally and/or remotely execute. The program code, for example, may be entirely or partially stored in local memory of the processor-controlled device. The program code, however, may also be at least partially remotely stored, accessed, and downloaded to the processor-controlled device. A user’s computer, for example, may entirely execute the program code or only partly execute the program code. The program code may be a stand-alone software package that is at least partly on the user’s computer and/or partly executed on a remote computer or entirely on a remote computer or server. In the latter scenario, the remote computer may be connected to the user’s computer through a communications network.

The disclosure may be applied regardless of networking environment. The communications network may be a cable network operating in the radio-frequency domain and/or the Internet Protocol (IP) domain. The communications network, however, may also include a distributed computing network, such as the Internet (sometimes alternatively known as the “World Wide Web”), an intranet, a local-area network (LAN), and/or a wide-area network (WAN). The communications network may include coaxial cables, copper wires, fiber optic lines, and/or hybrid-coaxial lines. The communications network includes wireless portions utilizing any portion of the electromagnetic spectrum and any signaling standard (such as the IEEE 802 family of standards, GSM/CDMA/TDMA or any cellular standard, and/or the ISM band). The communications network may even include powerline portions, in which signals are communicated via electrical wiring. The disclosure may be applied to any wireless/wireline communications network, regardless of physical componentry, physical configuration, or communications standard(s).

In some aspects, wireless communication interfaces may include, but are not limited to, an Intranet connection, Internet, Personal Area Networks (PANs) for the exchange of data over short distances, e.g., using short-wavelength radio transmissions in the industrial, scientific, and medical (ISM) band ISM band from 2400-2480 MHz) from fixed and mobile devices (e.g., Bluetooth® technology), wireless fidelity (Wi-Fi), Wi-Max, IEEE 802.1 1 technology, radio frequency (RF), Infrared Data Association (IrDA) compatible protocols, Local Area Networks (LANs), Wide Area Networks (WANs), Shared Wireless Access Protocol (SWAP), Zigbee, Near-Field Communication (NFC), LiFi, 5G, any combinations thereof, and other types of wireless networking protocols.

Certain aspects of disclosure are described with reference to various methods and method steps. It will be understood that each method step can be implemented by the program code and/or by machine instructions. The program code and/or the machine instructions may create means for implementing the functions/acts specified in the methods.

The program code may also be stored in a computer-readable memory that can direct the processor, computer, or other programmable data processing apparatus to function in a particular manner, such that the program code stored in the computer-readable memory produce or transform an article of manufacture including instruction means which implement various aspects of the method steps.

The program code may also be loaded onto a computer or other programmable data processing apparatus to cause a series of operational steps to be performed to produce a processor/computer implemented process such that the program code provides steps for implementing various functions/acts specified in the methods of the disclosure.

Any of a variety of light sources may be used to provide the excitation and/or imaging light, including but not limited to, tungsten lamps, tungsten-halogen lamps, arc lamps, lasers, light emitting diodes (LEDs), or laser diodes.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

For the purposes of this specification and appended claims, unless otherwise indicated, all numbers expressing amounts, sizes, dimensions, proportions, shapes, formulations, parameters, percentages, quantities, characteristics, and other numerical values used in the specification and claims, are to be understood as being modified in all instances by the term “about” even though the term “about” may not expressly appear with the value, amount, or range. Accordingly, unless indicated to the contrary, the numerical parameters set forth in the following specification and attached claims are not and need not be exact, but may be approximate and/or larger or smaller as desired, reflecting tolerances, conversion factors, rounding off, measurement error and the like, and other factors known to those of skill in the art depending on the desired properties sought to be obtained by the subject matter of the present disclosure. For example, the term “about,” when referring to a value can be meant to encompass variations of, in some embodiments ± 100%, in some embodiments ± 50%, in some embodiments ± 20%, in some embodiments ± 10%, in some embodiments ± 5%, in some embodiments ± 1%, in some embodiments ± 0.5%, and in some embodiments ± 0.1% from the specified amount, as such variations are appropriate to perform the disclosed methods or employ the disclosed compositions.

Further, the term “about” when used in connection with one or more numbers or numerical ranges, should be understood to refer to all such numbers, including all numbers in a range and modifies that range by extending the boundaries above and below the numerical values set forth. The recitation of numerical ranges by endpoints includes all numbers, e.g., whole integers, including fractions thereof, subsumed within that range (for example, the recitation of 1 to 5 includes 1, 2, 3, 4, and 5, as well as fractions thereof, e.g., 1.5, 2.25, 3.75, 4.1, and the like) and any range within that range.

All publications, patent applications, patents, and other references mentioned in the specification are indicative of the level of those skilled in the art to which the presently disclosed subject matter pertains. All publications, patent applications, patents, and other references are herein incorporated by reference to the same extent as if each individual publication, patent application, patent, and other reference was specifically and individually indicated to be incorporated by reference. It will be understood that, although a number of patent applications, patents, and other references are referred to herein, such reference does not constitute an admission that any of these documents forms part of the common general knowledge in the art.

Although the foregoing subject matter has been described in some detail by way of illustration and example for purposes of clarity of understanding, it will be understood by those skilled in the art that certain changes and modifications can be practiced within the scope of the appended claims.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

The foregoing description and accompanying figures illustrate the principles, embodiments and modes of operation of the disclosure. However, the disclosure should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the disclosure as defined by the following claims.

1. A microscope array system for providing epi-illumination, comprising:
a) a plurality of imaging systems arranged in an array, each imaging system comprising:i. an objective lens;ii. a tube lens;iii. an image sensor;iv. a beam splitter positioned between the objective lens and the tube lens; andv. a light pipe periscope configured to deliver illumination light to the beam splitter.

2. The microscope array system of claim 1, wherein the light pipe periscope comprises:
a) one or more light sources;b) condensing optics positioned over the one or more light sources;c) a light pipe configured to guide light from the one or more light sources; andd) an angled reflective element attached to a top end of the light pipe.

3. The microscope array system of claim 2, wherein the light pipe periscope further comprises:
a) an aperture configured to increase spatial coherence of the one or more light sources;b) one or more expanding optical elements; andc) a light baffle element.

4. The microscope array system of claim 1, wherein the beam splitter is a dichroic beam splitter.

5. The microscope array system of claim 1, wherein the array of imaging systems is arranged in a two-dimensional configuration.

6. The microscope array system of claim 1, wherein the light pipe periscope provides a structurally rigid means to deliver light from the one or more light sources to the beam splitter.

7. The microscope array system of claim 1, wherein the light pipe comprises a material with a single index of refraction that guides light via total internal reflection.

8. The microscope array system of claim 1, wherein the light pipe comprises an array of fibers.

9. The microscope array system of claim 1, wherein the light pipe comprises a cylindrical tube with a reflective interior.

10. The microscope array system of claim 1, further comprising a plurality of light pipe periscopes integrated onto a common optomechanical mount.

11. The microscope array system of claim 1, wherein each imaging system comprises two light pipe periscopes.

12. The microscope array system of claim 1, wherein the one or more light sources comprises one or more of: LEDs, lasers, laser diodes, VCSELs, or a micro-LED array.

13. The microscope array system of claim 1, further comprising an external light generating element configured to deliver light to the light source area via a fiber or fiber bundle.

14. The microscope array system of claim 1, further comprising one or more excitation filters positioned within an illumination optical path.

15. The microscope array system of claim 1, further comprising one or more emission filters positioned to filter emitted light from a sample.

16. A method for providing epi-illumination in a microscope array system, comprising:
a) generating illumination light from one or more light sources;b) guiding the illumination light through a light pipe periscope;c) redirecting the illumination light towards a beam splitter using an angled reflective element;d) reflecting the illumination light downwards through an objective lens using the beam splitter;e) collecting light from a sample through the objective lens;f) allowing the collected light to pass through the beam splitter to a tube lens; andg) directing the collected light from the tube lens to an image sensor.

17. The method of claim 16, further comprising:
a) increasing spatial coherence of the illumination light using an aperture; andb) expanding the illumination light using one or more expanding optical elements.

18. The method of claim 16, further comprising:
a) filtering the illumination light using an excitation filter; andb) filtering the collected light using an emission filter.

19. The method of claim 16, further comprising:
a) generating illumination light from a second light source;b) guiding the illumination light from the second light source through a second light pipe periscope; and c) redirecting the illumination light from the second light source towards a second beam splitter.

20. A microscope array system for providing epi-illumination, comprising:
a) a plurality of imaging systems arranged in an array, each imaging system comprising:i) an objective lens;ii) a tube lens;iii) an image sensor;iv) a beam splitter positioned between the objective lens and the tube lens; andv) an LED extension board configured to position one or more LEDs near the beam splitter for delivering illumination light.
